(19) United States
(12) Patent Application Publication
(10) Pub. No.: US 2007/0050822 A1
(43) Pub. Date: Mar. 1, 2007

(54) Method and system of providing shared community experience

(75) Inventors: Clarke Stevens, Littleton, CO (US); David K. Broberg, Lafayette, CO (US)

Correspondence Address: BROOKS KUSHMAN P.C., 1000 TOWN CENTER, TWENTY-SECOND FLOOR, SOUTHFIELD, MI, 48075, US

(73) Assignee: Cable Television Laboratories, Inc., Louisville, CO (US)

(21) Appl. No.: 11/216,513

(22) Filed: Aug. 31, 2005

(51) Int. Cl. H04N 7/18

(52) U.S. Cl. 725/74; 725/78

(57) ABSTRACT

A method of providing a shared community experience in an electronic system. The method may include transporting signals associated with common content to a group of subscribers such that each member of the group receives the same content and establishing the shared community experience between members of the group by providing communications between on or more members of the group during playback of the content.

### BACKGROUND OF THE INVENTION

1. Field of the Invention

The present invention relates to methods and system of providing a shared community experience through an electronic medium.

2. Background Art

A shared community experience may generally be considered as an experience where multiple community members at various locations simultaneously experience common content. The common content may relate to a television program, video, pictures, audio, or other form of electronic media, regardless of whether the media is live or pre-recorded that each member may commonly experience.

One problem with providing such a community experience relates to supporting communications between the members during the shared experience. Prior attempts to solve this problem have included placing a conference call independently of the mechanism used to deliver the content. This tends to be a cumbersome and expensive process.

### SUMMARY OF THE INVENTION

One non-limiting aspect of the present invention relates to overcoming the above-identified deficiencies and providing a more user-friendly, less cumbersome and expensive shared community experience.

One non-limiting aspect of the present invention relates to a method of providing a shared community experience in an electronic system. The method may include transporting signals associated with common content to a group of subscribers such that each member of the group receives the same content and establishing the shared community experience between members of the group by providing communications between one or more members of the group during playback of the content.

One non-limiting aspect of the present invention relates to a method of providing a shared community experience in a television system. The method may include transporting television signals associated with common content to a group of television service subscribers such that each member of the group receives the same content and establishing communications between members of the group such that each member of the group is able to communicate with each other, wherein the shared community experience is provided by the ability of each member of the group to receive the same content and communicate with each other.

The method may further include tuning a customer premise device associated with each of the members in the group to a particular television channel to display the content.

The method may further include providing presence information to members of the group and features to govern distribution of the presence information. The presence information may include information to indicate members of the group viewing the same content, to indicate content accessed by members of the group, or to indicate availability of the members to engage in the shared community experience.

The method may further included providing community information to members of the group, such as to share voting information of members of the group with respect to the content, to indicate ratings of the member of the group with respect to the content, or to indicate a question posed by one or more members of the group to the other members of the group.

The method may further included providing vendor specific information to members of the group.

The method may further included establishing verbal communications between members of the group, such as by establishing the verbal communications on a voice over internet protocol (VoIP) system which may be implemented on the set-top box or television. Optionally, the method may further include establishing textual communications between members of the group.

The method may further included transporting signals for displaying television content, video content, static image content, or interactive gaming between members of the group.

The method may further included providing a graphical user interface (GUI) for use by one or more of the television system subscribers in selecting members for inclusion within the group, such through settop box (STB) interfaces of the subscribers.

The method may further included establishing a group leader for controlling operations associated with the shared community experience, such as by providing the group leader with capabilities for controlling content provided to the group or for controlling participation in the group.

The method may further included providing the television signals from an upstream location associated with a television service provider and/or from a downstream location associated with one or more members of the group, such as from at least one of the group members and/or their DVRs.

One non-limiting aspect of the present invention relates to a system of providing a shared community experience in a cable television environment. The system may include a system provider associated with distributing content to a number of subscribers and a number of subscriber location devices configured to receive signals from the system provider and to manipulate the signals for displaying content on television located at the subscriber location.

The provider may be configured to simultaneously distribute common content to the televisions of multiple group members and to simultaneously establish communications between the group members so as to provide the shared community experience, such as to distribute the content over one or more television channels.

Optionally, the provider may be configured to receive the content from one or more of the group members and to distribute such group member originating content to the other group members. The provider may be associated with a cable television network for transporting the signals associated with the shared community experience between each group member.

The above features and advantages, along with other features and advantages of the present invention, are readily apparent from the following detailed description of the invention when taken in connection with the accompanying drawings.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates an electronic system in accordance with one non-limiting aspect of the present invention; and

FIG. 2 illustrates a flowchart of a method of providing a shared community experience in accordance with one non-limiting aspect of the present invention.

### DETAILED DESCRIPTION OF THE PREFERRED EMBODIMENT(S)

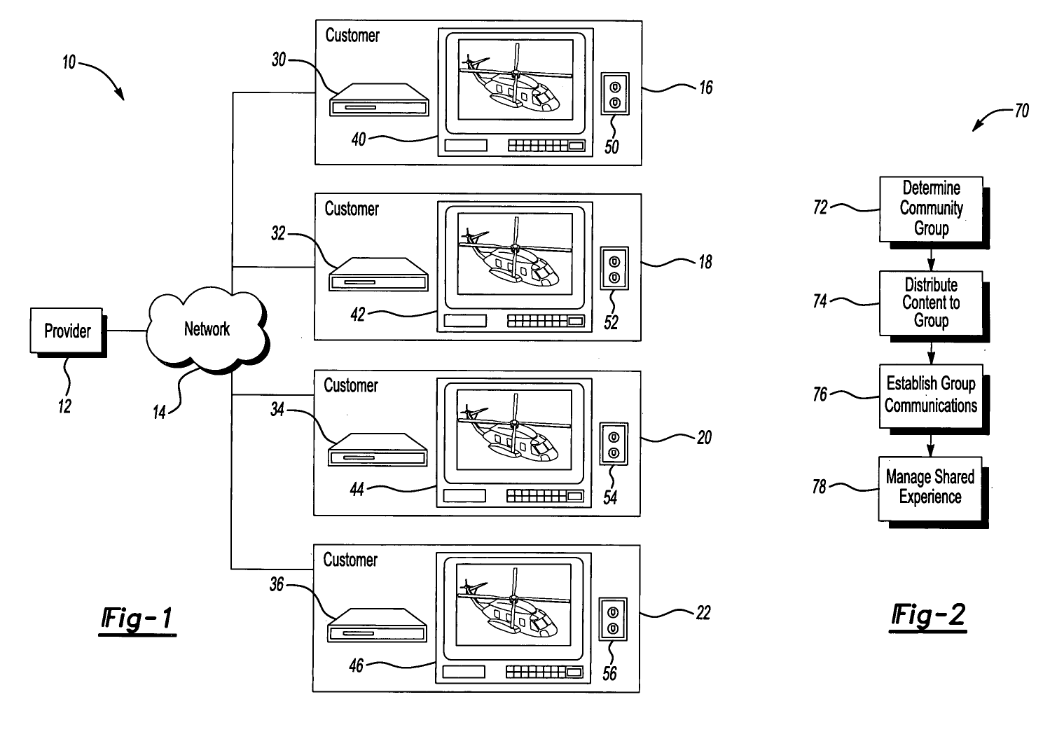

FIG. 1 illustrates an electronic system 10 in accordance with one non-limiting aspect of the present invention. The system 10 relates to any environment where a provider 12 transports or supports the transportation of electronic signals over a network 14 to one or more customer locations 16-22. The customer locations 16-22 may include any number of features for interacting with the network and services associated with the provider 12, including a settop box (STB) 30-36, television 40-46, and audio unit 50-56.

The provider 12 may be associated with any electronic service provider, such as a cable television, broadcast television, satellite television, telecommunications, data, and/or other provider. The provider 12 may provide any number of services, including television, video, audio, multi-media, data, interactive gaming, and the like.

The network 14 may include any number of features and options to support signal communications between the provider 12 and customer locations 16-22. The network 14 may include terrestrial and extraterrestrial components and infrastructures. It may include cable lines, telephone lines, and/or satellite or other wireless architectures. The network 14 may be associated with other private and/or public networks, such as the Internet and provider specific private networks.

The customer locations 16-22 are generally associated with different customers of the provider, commonly called subscribers. The subscribers, as shown, are associated with a common provider, however, the present invention is not so limited. Rather, the present invention fully contemplates subscribers being associated with different providers and located across any number of geographic regions, which may or may not require communications across different networks.

The customer locations 16-22 may include any number of features and devices, in addition to or in place of the illustrated STBs 30-36, televisions 40-46, and audio units 50-56. The customer premise devices may be configured to receive, output, and otherwise manipulate cable related signals for use by one or more customers. For example, a portion of the devices may be associated with settop boxes (STBs), modems, cable modems (CMs), computers, digital or personal video recorders (DVRs, PVRs), media terminal adapters (MTAs), and/or outlet digital adapters (ODAs). The customer location features are shown as separate, standalone features, however, the present invention fully contemplates combining the features and/or the functions associated therewith with other features in the system.

The provider 12, network 14, and customer premises devices may be configured to operate according to or support the operation of any number of protocols, applications, and procedures, including applications such as, but not limited to, linear and non-linear television programming (cable, satellite, broadcast, etc.), Video on Demand (VOD), interactive television (iTV), interactive gaming, pay-per-view (PPV), and protocols such as Hyper Text Transfer Protocol (HTTP), Dynamic Host Configuration Protocol (DHCP), Syslog, Simple Network Management Protocol (SNMP), Trivial File Transfer Protocol (TFTP), Data Over Cable Service Interface Specification (DOCSIS), Domain Name Server (DNS) applications, DOCSIS Settop Gateway (DSG), out-of-band (OOB) messaging, and others.

FIG. 2 illustrates a flowchart 70 of a method of providing a shared community experience in accordance with one non-limiting aspect of the present invention. For exemplary purposes, the method of the present invention is described with respect to its applicability in a cable television environment. The present invention, however, is not so limited and fully contemplates its application to any number of electronic environments. Block 72 relates to determining a community group. The community group may include any number of subscribers or other individuals having capabilities for communicating with each other over the network 14 or through other networking means. The community group may be used to identify multiple members for sharing the community experience.

The provider 12 or other entity associated with the system 10 may provide a graphical user interface (GUI) or other portal, such as a webpage or phone service, to facilitate selecting members for inclusion within the group. Optionally, a lead member may be identified with the group and granted various capabilities for controlling access thereto and governing the operation thereof. Any number of subscribers may create their own community groups and invite any number of other subscribers to join the group.

Block 74 relates to distributing shared content to the community members. The shared content may related to moving images, audio, video, static images (pictures), and other electronically transmissible content. The content may be transported through cable television signaling. Each member of the group desiring to share the content may be instructed or otherwise controlled to tune a particular television channel broadcasting the common content.

For example, the provider 12 or other feature associated with supporting the shared community may communicate signals to each member of the group, such as through an invitation procedure. A pop-up dialog may be displayed through graphical features of the STB to a user watching the television, such as through a VOD or EPG platform. The user may then select whether or not they would like to accept the content associated with the shared experience.

The content may be transported form a headend unit or other upstream feature associated with broadcasting or otherwise distributing television signals to the customer locations 16-22. Optionally, the content may be provided by one or more members of the group or other downstream location for distribution to the other members, such as if one of the members desires to stream video or digital pictures from a computer or DVR for display on the televisions of the other members. Such subscriber originated content may be distributed directly to the STBs 30-36 of the other members and/or to the headend or other system of the provider 12 for repackaging and distribution to the other group members through the cable network 14.

Block 76 relates to establishing communications between the members of the group. The communications may relate to verbal, text, video, or other communications between the members. The communications preferably allow each member of the group to communicate with the other members during viewing of the shared content. The communications may be provided between individual members of the group (one-to-one) and/or between multiple members of the group (one-to-many) For example, the audio unit may be connected with the STB of each member to record and play audio. Each STB 40-46 may communicate the audio signals to the other STBs 40-46 in real-time to support communications between the group members.

Similarly, the STBs 30-36 may establish textual communications where text messages from other members of the group are displayed in a pop-up window or other feature displayed in the televisions 40-46. Identifiers and other features may be included to identify the users in the window and the text messages associated therewith, similar to an instant messaging arrangement.

The ability to support audio and/or textual communications through the STBs 30-36 may be advantageous to facilitate ease of use of the shared experience as the software and other logic associated with supporting the communications is removed from the user thereof, thereby eliminating the need of the user to support complex communication systems. The audio units 50-56 may be plug-and-play type devices or other similarly user-friendly devices to support verbal communications through with the other members and may include a USB or other easily connectable feature for connecting to one or both of the STBs 30-36 and/or television 40-46.

Block 78 relates to managing the shared experience. The management may relate to any number of features associated with enhancing or otherwise servicing the shared experience. This may include features for displaying information collected during monitoring to other members of the group and/or a system operator in charge of supporting the shared experience. Optionally, the members may include preferences and other features for governing the various management options, especially with respect to options associated with reporting activities of the users

One management feature may include providing presence information to the other members of the group. The presence information may be used to identify the other members of the group to each other. A menu or other feature may be displayed in a portion of the television to indicate the other members in the group, and optionally, a status of the other members, such as an indication of which content is being accessed by the members, i.e., to indicate whether the other members are participating in the share experience. The presence information may also be used to indicate availability of the other members to join the shared experience, such as requesting the member to input a message indicating their desire to be included with current or future shared community opportunities.

Another management feature may include providing community information to members of the group. The community information may include user requested or system provided voting information to facilitate voting on the shared content, such as by providing prompts and other inputs to the user for rating the quality of the content. Optionally, each user may be permitted to post community information for other members of the group to view, such as to post to a comment or question to the group.

Another management feature may include providing vendor specific information to the group members. The vendor specific information may relate to data and other information accepted by the group for display during the shared experiences, such as members of the group agree to view a banner or pop-up window having advertisements or other vendor specific information during viewing.

Another management feature may include allowing the group leader or other member of the group to manage content shared with other members. The group leader may specify viewing schedules and other plans to facilitate controlling content shared with other members of the group. Optionally, the provider may supersede or otherwise arbitrate the content shared amongst the community, such as to limit distribution of vulgar and/or salacious materials.

One aspect of the present invention relates to permitting television service providers to leverage off of available network-based infrastructure to support multi-way communications as well as “leader-based” services that would allow the organizer of the group to automatically tune the televisions of participants. Service providers may also provide the software on the set-top box to enable the service and recoup their costs by forcing the consumer to pay for the use of the service. The community experience may be centered around the television but not limited by location.

In one embodiment, the present invention allows users to select one or more people from a list of MSO or non-MSO subscribers to join a “TV-Together” group. The selected participants may tune (or are automatically tuned by the group leader) to a common television channel and are connected (preferably through the set-top box) in a multi-way audio conference call. This call may be provisioned via SIP and connected using VoIP. A simple speaker phone device may be connected either to the set-top box or to the home network for the multi-way audio call. The management of the entire process may be handled through the TV/set-top box and the remote control. The participants may be able to naturally communicate with each other while watching a common sports event, movie, favorite television show, etc. The system can (as specified in user preferences and dependent on the capabilities of the set-top) be allowed to have channels tuned, web pages visited or other functions performed automatically under the control of the remote group leader.

Alternative implementations may add text messaging or video. The system may work equally well with interactive games, viewing family photographs, or any other TV-based shared experience. Participants can choose to expose information (such as whether the TV is on and what channel is tuned) to other people on their “buddy list.” This system may move the experience to the television in a social area of the home and provides a managed system provided by the television service provider on simple television platform.

A digital photograph stored on a user PC can be uploaded to a secure location on the service provider network. Any users on a list of authorized users may then locate this photograph using a user interface on the television set-top box and view the image on the television set. Additional features of the system may include additional media types (sound files, digital video, etc.) and combinations of media types (slide shows set to music, PowerPoint presentations, etc.). The system may also allow for synchronized and managed presentation of the media combined with real-time, multi-way communications (VoIP conference call, video conference call, instant messaging, etc.). In this scenario, a group leader can control the presentation of the media. All communications may be secured. Personal media can be shared freely, but copy controlled content will follow copy control rules (i.e. it may not be shareable, it may be transferable if the original copy is destroyed, etc.).

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of providing a shared community experience in a television system, the method comprising:
transporting television signals associated with common content to a group of television service subscribers such that each member of the group receives the same content;
establishing communications between members of the group such that each member of the group is able to communicate with each other; and
wherein the shared community experience is provided by the ability of each member of the group to receive the same content and communicate with each other.

2. The method of claim 1 further comprising tuning a customer premise devices associated with each of the members in the group to a particular television channel to display the content.

3. The method of claim 1 further comprising providing presence information to members of the group.

4. The method of claim 3 further comprising providing features to members of the group to govern distribution of the presence information, to indicate members of the group viewing the same content, to indicate content accessed may members of the group, or to indicate availability of the members to engage in the shared community experience.

5. The method of claim 1 further comprising providing community information to members of the group.

6. The method of claim 5 further comprising configuring the community information to share voting information of members of the group with respect to the content, to indicate ratings of the member of the group with respect to the content, or to indicate a questions posed by one or more members of the group to the other members of the group.

7. The method of claim 1 further comprising providing vendor specific information to members of the group.

8. The method of claim 1 further comprising establishing verbal communications between members of the group.

9. The method of claim 8 further comprising establishing the verbal communications on a voice over internet protocol (VoIP) system.

10. The method of claim 1 further comprising establishing textual communications between members of the group.

11. The method of claim 1 further comprising transporting signals for displaying television content, video content, static image content, or interactive gaming between members of the group.

12. The method of claim 1 further comprising providing a graphical user interface (GUI) for use by one or more of the television system subscribers in selecting members for inclusion within the group.

13. The method of claim 12 further comprising providing the GUI through settop box (STB) interfaces of the subscribers.

14. The method of claim 1 further comprising establishing a group leader for controlling operations associated with the shared community experience.

15. The method of claim 14 further comprising providing the group leader with capabilities for controlling content provided to the group or for controlling participation in the group.

16. The method of claim 1 further comprising providing the television signals from an upstream location associated with a television service provider.

17. The method of claim 1 further comprising providing the television signals from a downstream location associated with one or more members of the group.

18. The method of claim 1 further comprising originating the content from at least one of the group members.

19. The method of claim 18 further comprising originating the content from a digital video recorder (DVR) of at least one of the group members.

20. A method of providing a shared community experience in an electronic system, the method comprising:
transporting signals associated with common content to a group of subscribers such that each member of the group receives the same content; and
establishing the shared community experience between members of the group by providing communications between on or more members of the group during playback of the content.

21. The method of claim 20 further comprising providing the content through television signaling.

22. A system of providing a shared community experience in a cable television environment, the system comprising:
a system provider associated with distributing content to a number of subscribers;
a number of subscriber location devices configured to receive signals from the system provider and to manipulate the signals for displaying content on television located at the subscriber location;
wherein the system provider is further configured to simultaneously distribute common content to the televisions of multiple group members and to simultaneously establish communications between the group members so as to provide the shared community experience.

23. The system of claim 22 wherein the provider is configured to distribute the content over one or more television channels.

24. The system of claim 22 wherein the provider is configured to receive the content from one or more of the group members and to distribute such group member originating content to the other group members.

25. The system of claim 22 further comprising a cable television network for transporting the signals associated with the shared community experience between each group member.
